(19) United States
(12) Patent Application Publication
(10) Pub. No.: US 2025/0104425 A1
(43) Pub. Date: Mar. 27, 2025

(54) Systems and Methods for Dynamic Video Generation

(71) Applicant: GameChanger Media, Inc., New York, NY (US)

(72) Inventors: Leonard Grazian, Bentonville, AR (US); Kevin Aguilar, Austin, TX (US); Sean McMillan, Saline, MO (US)

(73) Assignee: GameChanger Media, Inc., New York, NY (US)

(21) Appl. No.: 18/898,161

(22) Filed: Sep. 26, 2024

Related U.S. Application Data
(60) Provisional application No. 63/540,858, filed on Sep. 27, 2023.
(60) Provisional application No. 63/547,193, filed on Nov. 3, 2023.

(51) Int. Cl. G06V 20/40; G06T 3/40; G06T 7/70; G06V 10/25

(52) U.S. Cl. CPC G06V 20/42; G06T 3/40; G06T 7/70; G06V 10/25; G06T 2207/20132; G06V 2201/07

(57) ABSTRACT

In some aspects, the disclosure is directed to systems and methods for dynamic video generation. A system may include one or more processors that are configured to obtain a video of a game session in which one or more participating; detect a set of individuals depicted in the video of the game session, the set of individuals comprising the plurality of participants; determine a location for each of the plurality of participants; determine an action location of the video as a function of the location of each of the plurality of participants; and adjust a zoom characteristic of the video based on the action location.

### CROSS-REFERENCE TO RELATED APPLICATIONS

This application claims the benefit of priority to U.S. Provisional Application No. 63/540,858, filed Sep. 27, 2023, and to U.S. Provisional Application No. 63/547,193, filed Nov. 3, 2023, the entirety of each of which is incorporated by reference herein.

### BACKGROUND OF THE DISCLOSURE

Many people attempt to capture videos of sporting events that they attend. People do so for a variety of reasons, such as to capture memories of certain participants playing or to capture film of specific events that occur during the sporting events that can later be reviewed by the participants in the sporting events for improvement.

There are inherent technical challenges in filming the sporting events, particularly when a camera is operating autonomously to do so. For example, basketball games are characterized by fast-paced and unpredictable movements. Capturing these dynamic scenes necessitates high frame rates and quick autofocus to ensure clarity and continuity. Traditional filming equipment and techniques can struggle to adapt to the abrupt and spontaneous shifts typical in basketball games, resulting in missed moments and diminished video quality. In another example, with the large amount of movement that can occur in sporting events, it can be difficult for an autonomous camera attempting to focus on the important parts of the game to identify where to direct the lens or zoom in on the activity.

### SUMMARY

In some aspects, the present disclosure describes one or more non-transitory computer-readable media for dynamic video generation, the non-transitory computer readable-media comprising instructions which, when executed by one or more processors, cause the one or more processors to: obtain a video of a game session in which a plurality of participants are participating; detect a set of individuals depicted in the video of the game session, the set of individuals comprising the plurality of participants; determine a location for each of the plurality of participants within the video; determine an action location of the video as a function of the location of each of the plurality of participants within the video; and adjust a zoom characteristic of the video based on the action location.

In some embodiments, execution of the instructions causes the one or more processors to identify the plurality of participants of the game session from the detected set of individuals detected in the video of the game session. In some embodiments, execution of the instructions causes the one or more processors to identify the plurality of participants responsive to determining the plurality of participants are located within a defined area of the video.

In some embodiments, execution of the instructions further causes the one or more processors to receive the defined area as a user input. In some embodiments, execution of the instructions further causes the one or more processors to automatically identify the defined area from the video based on visual characteristics of a playing area for the game session depicted in the video.

In some embodiments, execution of the instructions causes the one or more processors to determine the location for each of the plurality of participants by establishing a one-dimensional graph with an axis along a width of the video; and determining the location for each of the plurality of participants within the video on the one-dimensional graph. In some embodiments, execution of the instructions causes the one or more processors to determine the action location of the video by determining a median of the location of each of the plurality of participants.

In some embodiments, execution of the instructions causes the one or more processors to adjust a zoom characteristic of the video by zooming in on the video according to a preconfigured zoom setting to generate zoomed-in frames of the video; and moving the zoomed-in frames of the video such that the action location is within the zoomed-in frames. In some embodiments, execution of the instructions causes the one or more processors to move the zoomed-in frames of the video such that the action location is in a middle of the zoomed-in frames. In some embodiments, execution of the instructions causes the one or more processors to crop out any portions of the video that are not included in the zoomed-in frames.

In some embodiments, execution of the instructions causes the one or more processors to transmit the zoomed-in frames to a remote computing device. In some embodiments, execution of the instructions causes the one or more processors to detect the set of individuals depicted in the video of the game session using an object detection machine learning model. In some embodiments, execution of the instructions causes the one or more processors to store one or more first frames of the video in memory; determine the action location of the video as a function of the location of each of the plurality of participants within the video for each of the one or more first frames of the video; receive a second frame of the video subsequent to receiving the one or more first frames; and adjust the zoom characteristic of the video by placing coordinates of the action location in a middle of the second frame received subsequent to the one or more first frames of the video. In some embodiments, execution of the instructions causes the one or more processors to determine the action location of the video as a function of the location of each of the plurality of participants within the video for each of a plurality of first frames of the one or more first frames of the video.

In some aspects, the present disclosure describes a system for dynamic video generation. The system can include one or more processors coupled to one or more computer-readable storage media, the one or more processors configured to execute instructions stored on the one or more computer-readable storage media to obtain a video of a game session in which a plurality of participants are participating; detect a set of individuals depicted in the video of the game session, the set of individuals comprising the plurality of participants; determine a location for each of the plurality of participants within the video; determine an action location of the video as a function of the location of each of the plurality of participants within the video; and adjust a zoom characteristic of the video based on the action location. In some embodiments, execution of the instructions causes the one or more processors to identify the plurality of participants of the game session from the detected set of individuals detected in the video of the game session.

In some embodiments, execution of the instructions causes the one or more processors to identify the plurality of participants responsive to determining the plurality of participants are located within a defined area of the video. In some embodiments, execution of the instructions further causes the one or more processors to receive the defined area as a user input. In some embodiments, execution of the instructions further causes the one or more processors to automatically identify the defined area from the video based on visual characteristics of a playing area for the game session depicted in the video.

In some aspects, the present disclosure describes a method for dynamic video generation. The method can include obtaining, by one or more processors, a video of a game session in which a plurality of participants are participating; detecting, by the one or more processors, a set of individuals depicted in the video of the game session, the set of individuals comprising the plurality of participants; identifying, by the one or more processors, the plurality of participants of the game session from the detected set of individuals detected in the video of the game session responsive to determining the plurality of participants are located within a defined area of the video; determining, by the one or more processors, a location for each of the plurality of participants within the video; determining, by the one or more processors, an action location of the video as a function of the location of each of the plurality of participants within the video; and adjusting, by the one or more processors, a zoom characteristic of the video based on the action location.

In some embodiments, the method further includes receiving, by the one or more processors, the defined area as a user input. In some embodiments, the method further includes automatically identifying, by the one or more processors, the defined area from the video based on visual characteristics of a playing area for the game session depicted in the video.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a system for dynamic video generation, according to some implementations;

FIG. 2 is a sequence diagram of an implementation of a computing device configured for dynamic video generation, according to some implementations;

FIG. 3 is a sequence diagram of identifying participants of a game session, according to some implementations;

FIG. 4 is a depiction of characteristics of an implementation of modifying frames of a video, according to some implementations;

FIG. 5 is a flow chart of a method for dynamic video generation, according to some implementations;

FIGS. 6A and 6B are block diagrams depicting embodiments of computing devices that can be used in connection with the methods and systems described herein; and

FIGS. 7A and 7B depict comparisons between modified and unmodified images, according to some implementations.

The details of various embodiments of the methods and systems are set forth in the accompanying drawings and the description below.

### DETAILED DESCRIPTION

For purposes of reading the description of the various embodiments below, the following descriptions of the sections of the specification and their respective contents may be helpful:
Section A describes embodiments of systems and methods for dynamic video generation; and
Section B describes a computing environment which can be used for practicing embodiments described herein.

### A. Systems and Methods for Dynamic Video Generation

As briefly mentioned above, the rise of video recording and streaming of sporting events or game sessions has grown exponentially. This has led to the development of various methods for recording, presenting, and sharing gameplay sessions captured on video. However, current video capture and sharing methods suffer from a number of limitations. For example, game sessions are often visually complex with multiple actions occurring at various locations within the recorded video. This can make it challenging for viewers to follow the gameplay, especially when viewing on smaller screens or when there is a large number of participants in the game. Moreover, the action in gameplay videos is not always centralized, it can happen anywhere in the frame, depending on the movements of the participants. Conventional techniques of recording game session often involve a camera in a static position that records the game session with a set frame and field of view. Such techniques can result in less relevant areas being shown in the video while the key action happens off-screen.

A computer implementing the systems and methods described herein can overcome the aforementioned technical challenges. For example, the computer can obtain a video of a game session in which a plurality of participants are participating. The computer can obtain the video from a camera capturing the video or from memory. The game session can be a sports game session or any other type of game session. The game session may be a game, match, practice, meet, etc., for example. The computer can detect a set of individuals depicted in the video of the game session. The computer can detect the set of individuals using an object detection machine learning model (e.g., a neural network), for example. The set of individuals can include the plurality of participants participating in the game session. The computer can determine locations (e.g., coordinates within the frames of the video) of the participants of the game session within the video. The computer may determine the locations on a one-dimensional graph, such as by determining the coordinates of each of the plurality of participants within the video on an x-axis. The computer can execute a function using the locations of the participants to determine an action location of the participants, such as by determining a median of the locations of the participants. The computer can adjust a zoom characteristic of the video based on the action location. The computer can do so, for example, by zooming in on a frame of the video by a defined zoom amount and setting the action location in the middle of the frame. The computer can crop out the portions of the video that are not included in the zoomed-in frame. In this way, the computer can automatically edit a video stream of a game session to focus on the action without relying on any movement by the camera operator capturing the video, or the computer can edit a stored video of a game session that was completed in the past.

A problem that can arise when automatically editing a video of a game session is that individuals that are not participating in the game session may be detected within the video. For example, a machine learning model executed by a computer performing the systems and methods described herein may detect spectators for a game session in addition to the actual participants of the game session from a video feed of the game session. Because the spectators are not participating in the game session, it may be undesirable to perform any zoom determinations based on the locations of the spectators. To avoid doing so, the computer can define an area in which the game session is being completed. The computer can use the area to filter out any individuals that the computer detects using object detection techniques that are not within the area, such as by only including individuals with portions of detected bounding boxes (e.g., bottom corners of bounding boxes) that are within the area. The computer can remove individuals that do not satisfy such a criterion from consideration in determining the action location of the video. For example, the computer can execute a function only on the coordinates of individuals that have not been removed from consideration.

Another problem that can arise when automatically editing videos of a game session is that often times game sessions can involve sudden and/or unexpected movements by different individuals, such as when there are multiple turnovers in a row. While a human operator may understand such courses of events and not overcorrect for the sudden changes in movement, an automated editing technique that a computer may use in these situations may result in jerky movements in the edited video. To avoid such jerky movements, the computer performing the systems and method described herein may perform a look-ahead technique on the frames of the video. For example, the computer may identify an action location based on coordinates of participants in a game session based on one or more previously captured frames of video. The computer can use the determined action location on a later captured frame of the video to edit the later captured frame. In doing so, the computer can use smoothed versions of the action location to zoom in on individual frames of the video and not overcorrect due to sudden changes in locations of the participants of the game session.

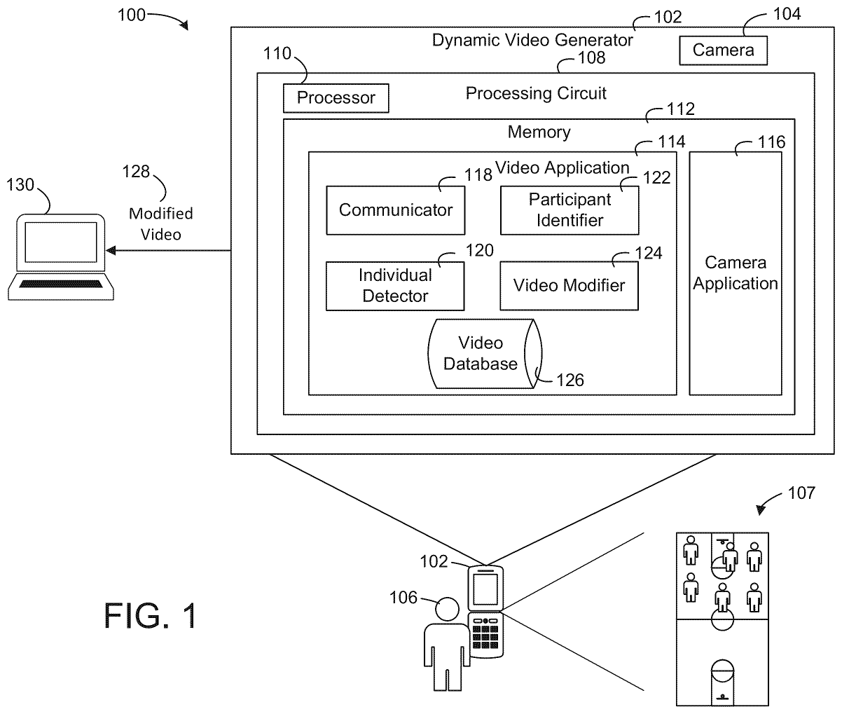

For example, referring now to FIG. 1, a block diagram of a system 100 for dynamic video generation is shown, according to some implementations. The system 100 may include a dynamic video generator 102 and a remote computing device 130, in some embodiments. The dynamic video generator 102 can communicate with the remote computing device 130 over a network. The dynamic video generator 102 can capture videos of game sessions and modify the videos to zoom in on the activity within the game sessions. The dynamic video generator 102 can remove or crop out the portions of the videos that are not included in the zoomed-in portions of the videos to generate modified versions of the videos. The dynamic video generator 102 can modify captured video streams in real time and/or modify stored videos. The dynamic video generator 102 can store the modified videos or video streams or transmit the modified videos or video streams to the remote computing device 130. In some embodiments, the dynamic video generator 102 can transmit unmodified versions of videos to the remote computing device 130 and the remote computing device 130 can perform the same operations to modify the videos.

The dynamic video generator 102 may be or include any type and/or form of media device or computing device, including a mobile phone, desktop computer, laptop computer, portable computer, tablet computer, wearable computer, embedded computer, smart television, set top box, console, Internet of Things (IoT) device or smart appliance, or any other type and form of computing device. The dynamic video generator 102 can be a server or cloud computer configured to generate videos received over the Internet, such as through a web-based interface. Computing device(s) may be referred to variously as a client, device, client device, computing device, anonymized computing device or any other such term. In some cases, the dynamic video generator 102 can be recording hardware that is not a personal mobile device. Computing devices and intermediary modulators may receive media streams via any appropriate network, including local area networks (LANs), wide area networks (WANs) such as the Internet, satellite networks, cable networks, broadband networks, fiber optic networks, microwave networks, cellular networks, wireless networks, or any combination of these or other such networks. In many implementations, the networks may include a plurality of subnetworks which may be of the same or different types, and may include a plurality of additional devices (not illustrated), including gateways, modems, firewalls, routers, switches, etc.

The dynamic video generator 102 may be accessed by a user 106. The user 106 may be a person watching a game session 107. The game session 107 may be, for example, a game for a sport, such as baseball, basketball, soccer, football, hockey, etc., or any other type of game session. The user 106 can hold the dynamic video generator 102 and use a camera 104 (e.g., a video camera) of the dynamic video generator 102 to capture or generate a video stream of the game session 107. In some cases, the camera 104 can be an external camera to the dynamic video generator 102 that captures and transmits video to the dynamic video generator 102.

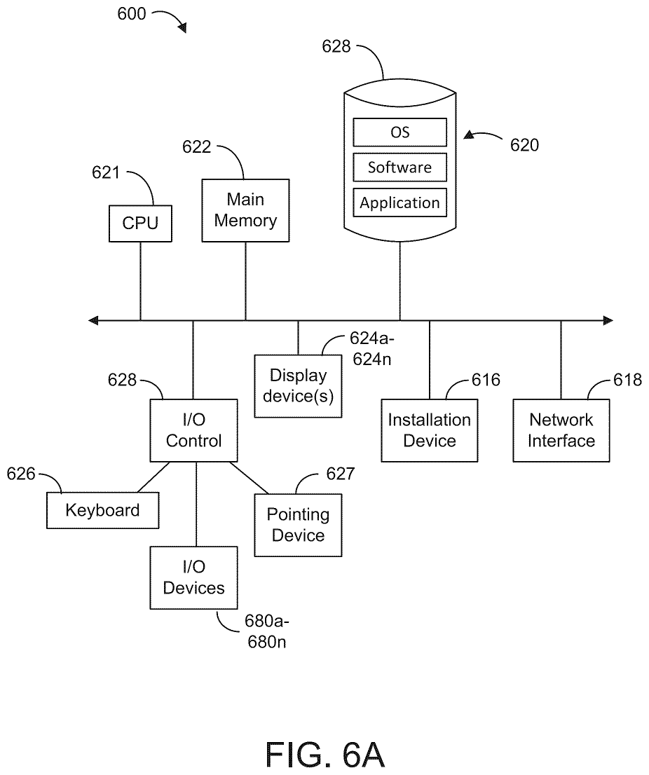

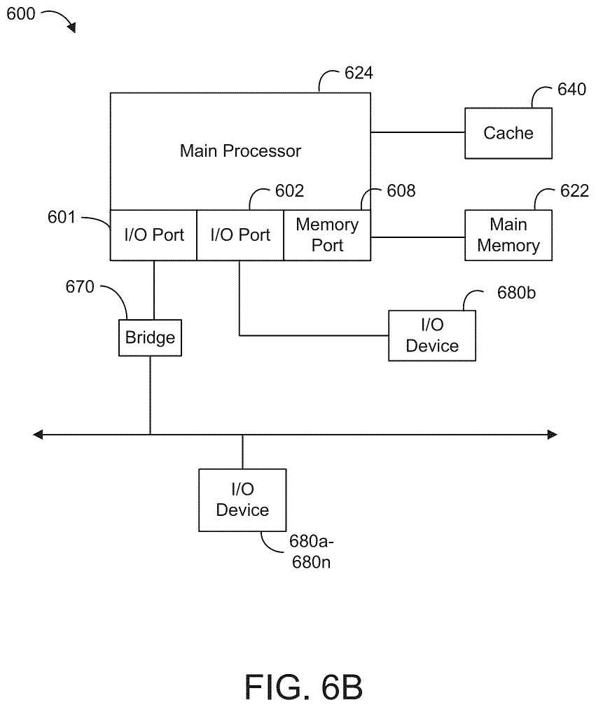

The dynamic video generator 102 may include a processing circuit 108, a processor 110, and a memory 112. The processing circuit 108, the processor 110, and/or the memory 112 can correspond to or be the same as components described with reference to FIGS. 6A and 6B. The dynamic video generator 102 can communicate with the remote computing device 130 and other client devices or computing devices over a network (e.g., a synchronous or asynchronous network). The dynamic video generator 102 can operate as a local client device that receives and processes videos captured by the local client device or from a camera on the same local communication network (e.g., local area network (LAN)), or the dynamic video generator 102 can operate in the cloud or as a server that receives and processes videos or video streams across a network (e.g., the Internet).

The memory 112 may include a video application 114 and a camera application 116. The video application 114 can be configured to modify videos (e.g., stored videos or video streams received in real-time). The camera application 116 can operate to control operation of the camera 104, such as to control a zoom operation, control whether the camera 104 is operating to capture video, and/or control any settings for video capture. The camera application 116 can receive video (e.g., a sequence of frames and/or corresponding audio of frames) captured by the camera 104 over time and transmit or direct the video to the video application 114. The camera application 116 can operate based on user input at the dynamic video generator 102. The memory 112 may include any number of components.

The video application 114 can include a communicator 118, an individual detector 120, a participant identifier 122, a video modifier 124, and/or a video database 126. One or more of the components 118-126 can be components of an application configured to receive video from the camera 104 or an application of the dynamic video generator 102 operating the camera 104 and can modify the video or video stream to focus on specific portions of the video stream to generate a modified video or modified video stream. In some embodiments, one or more of the components 118-126 can be web-based and can be configured to receive videos or video streams over a network to generate the modified videos or modified video streams.

The communicator 118 can include instructions performed by one or more servers or processors (e.g., the processing circuit 108), in some embodiments. The communicator 118 may be or include one or more application programming interfaces (APIs) that facilitate communication between the dynamic video generator 102 and other computing devices, such as the remote computing device 130 or other applications stored in the memory 112, such as the camera application 116 to receive video.

The communicator 118 can establish connections with computing devices (e.g., the remote computing device 130). The communicator 118 can establish connections with the computing devices over a network. To do so, the communicator 118 can communicate with the computers across the network. In one example, the communicator 118 can transmit syn packets to the computers (or the computers can transmit syn packets to the communicator 118) and establish the connections using a TLS handshaking protocol. The communicator 118 can use any handshaking protocol to establish connections with the computers.

The communicator 118 can receive video streams from the camera application 116. For example, the user 106 may operate the dynamic video generator 102 to capture a video of the game session 107 using the camera 104 through the camera application 116. While doing so, the camera application 116 can receive the video (e.g., the frames of the video and/or corresponding audio of the frames) in real-time as a video stream and transmit the video stream to the communicator 118 of the video application 114.

The individual detector 120 can include instructions performed by one or more servers or processors (e.g., the processing circuit 108), in some embodiments. The individual detector 120 can be configured to analyze frames of the video stream that the communicator 118 receives from the camera application 116. The individual detector 120 can analyze the frames to detect individuals or humans in the frames. The individual detector 120 can do so, for example, by executing a machine learning model (e.g., an object detection machine learning model, such as yolos-tiny (a transformer model) or a convolutional neural network) that is configured to receive images (e.g., frames) as input and detect specific types of objects within the images. The machine learning model can be configured or trained to detect individuals in images. The individual detector 120 can be configured to receive the video stream captured by the camera 104 from the communicator 118 and execute the machine learning model to detect individuals in the images of the video stream. To preserve processing resources and/or reduce latency, the individual detector 120 can perform such detection techniques at a defined frequency on the received images of the video stream (e.g., detect individuals every two images or frames of the video stream, detect individuals at a rate of two frames-per-second or 15 frames-per-second, or at any other rate). The individual detector 120 can perform such detection techniques at any frequency. The individual detector 120 can detect the individuals and generate bounding boxes around the individuals to indicate the locations of the individuals within the images of the video stream. The individual detector 120 may not detect the ball or object that is the focus of the game session (e.g., the basketball, the soccer ball, the hockey puck, etc.) in performing the object detection.

In some embodiments, the individual detector 120 can detect individuals at a rate within different rate ranges. For example, the individual detector 120 can detect images at a rate within a range of one frame-per-second to 30 frames-per-second (which may be higher or lower by the speed at which the camera generating the images of the video stream generates or transmits the images of the video stream), one frame-per-second to 15 frames-per-second, or 15 frames-per-second to 30 frames-per-second. In some embodiments, 30 frames can be the maximum rate because the system can take approximately 30 milliseconds to execute, and the camera can capture images at a rate of 30 frames-per-second. Accordingly, embodiments that execute faster and/or that capture images at a faster rate can operate within ranges of higher boundaries.

The frequency of individual detection may depend on the type of device performing the detection techniques. For example, operating within a mobile phone, the individual detector 120 may operate within the range of one frame-per-second to 15 frames-per-second. Operating on a server in the cloud, the individual detector 120 may operate with the range of one frame-per-second to 30 frames-per-second or 15 frames-per-second to 30 frames-per-second. Such differences may result from the computing capacity of the different types of devices. The benefits of running in a lower range of frames-per-second are that doing so can preserve battery life of the device and provide spare computing resources to run more models in the future. Such may be important when operating on a user's device (e.g., mobile device), for example. The trade-off of operating within a low range of frames-per-second is that doing so can result in collecting or generating limited information regarding the locations of participants within the video feed, which can reduce the quality of the output. Because a server in the cloud may not have such constraints, the cloud server may operate at the highest frame-per-second possible or within the highest range of frames-per-second possible.

The participant identifier 122 can include instructions performed by one or more servers or processors (e.g., the processing circuit 108), in some embodiments. The participant identifier 122 can be configured to identify or select participants in game sessions from the individuals detected or identified by the individual detector 120. The participant identifier 122 can identify participants in game sessions based on the participants being within a defined area of the images of the video stream. For example, the user 106 can input the boundaries of a playing area of the game session 107 to create a defined area. In doing so, the user 106 can input (e.g., into a user interface generated by the video application 114) the boundaries to be the boundaries of a basketball court (e.g., the out-of-bounds lines on the basketball court) or boundaries a distance from the boundaries of the basketball court. The input boundaries can be the defined area. In another example, the participant identifier 122 can automatically generate the defined area. The participant identifier 122 can do so, for example, by using machine learning image processing techniques on the images of the video stream. The participant identifier 122 can execute a machine learning model to identify the lines of the basketball court. The participant identifier 122 can automatically set the defined area to be the lines of the basketball court or a defined distance outside of the lines of the basketball court. By setting the lines outside of the basketball court, the participant identifier 122 can ensure that participants in the game session that temporarily leave the court during the game session are still identified as participants in the game session.

The participant identifier 122 can identify participants in game sessions based on the defined area and the bounding boxes of the individuals generated by the individual detector 120. For example, the participant identifier 122 can identify the locations of the bounding boxes. In doing so, the participant identifier 122 can identify the locations of the outlines of the bounding boxes. The participant identifier 122 can compare the locations of the outlines of the bounding boxes to the defined area. The participant identifier 122 can use one or more rules to identify participants in the game session based on the comparison. For example, the participant identifier 122 can determine an individual is a participant in the game session responsive to determining a percentage of a bounding box for the participant is within the defined area. In another example, the participant identifier 122 can determine an individual is a participant in the game session responsive to determining one or both of a defined corner or edge of the bounding box (e.g., one or more both of the bottom corners of a bounding box) for the participant is within the defined area. The participant identifier 122 can use any rule or any number of rules to identify participants in this way. The participant identifier 122 can compare each of the bounding boxes identified by the individual detector 120 to the defined area and the defined rules to identify participants in the game session. In this way, the participant identifier 122 can avoid including spectators of game sessions as participants in the game sessions.

In some embodiments, the participant identifier 122 can identify participants in a game session without identifying or using a defined area within frames of a video. The participant identifier 122 can do so using a participant detection machine learning model (e.g., a convolutional neural network) that has been trained to identify game session participants without a bounding area. For example, the participant identifier 122 (or another computing device) can feed training data of frames of videos into the participant detection machine learning model for training. The training data can include labels identifying participants of game sessions and/or individuals depicted in the frames but that are not participants of the game sessions themselves. The participant detection machine learning model can be configured to generate bounding boxes of individuals with labels indicating whether the individuals are participants of game sessions or not. In some cases, the participant detection machine learning model can be trained to only identify participants of game sessions with training data in which only participants of the game session are labeled or identified. The participant identifier 122 can execute the participant detection machine learning model using the training data to cause the participant detection machine learning model to detect individuals depicted in the frames and/or label the individuals as participants. The participant identifier 122 can generate such predictions based on context within the frames, such as a background of the playing environment, or the area depicted around individual participants, positions of the detected individuals relative to each other, etc. The participant identifier 122 can use back-propagation techniques based on differences in the labels and/or the predictions to adjust the weights and/or parameters of the participant detection machine learning model to more accurately identify participants in the game sessions. The participant identifier 122 can train the participant detection machine learning model in this way over time and/or for different training datasets until the participant detection machine learning model can accurately (e.g., above an accuracy threshold) identify participants participating in game sessions. In doing so, the participant identifier 122 can increase the accuracy of identifying participants of game sessions such that the participant identifier 122 can more reliably identify players within the playing area. Additionally, training the participant detection machine learning model in this way can reduce the amount of time it takes to identify participants in game sessions from frames (e.g., by removing the multi-step process of the individual detector 120 first detecting individuals in a video and then filtering the participants to only identify participants within a defined area of the video and, in some cases, by removing a requirement of a user inputting the location of the defined area) such that the dynamic video generator 102 can modify the video with less processing power and less latency, which can cause any modifications to the video for zooming and/or panning to be more accurate.

Given the differing backgrounds and/or environments of different types of game sessions (e.g., different sports), the participant identifier 122 can train different participant detection machine learning models for each type of game session to detect participants in the game session. For example, the participant identifier 122 can train one participant detection machine learning model to detect participants of a soccer game and one participant detection machine learning model to detect participants of a basketball game. The participant identifier 122 can do so, for example, by only training the soccer participant detection machine learning model with videos of soccer games and only training the basketball participant detection machine learning model with videos of basketball games. The participant identifier 122 can train participant detection machine learning models to detect participants for any type of game session.

The video modifier 124 can include instructions performed by one or more servers or processors (e.g., the processing circuit 108), in some embodiments. The video modifier 124 can be configured to modify the video or video stream received from the camera application 116. The video modifier 124 can do so based on the participants that the participant identifier 122 identified from the images of the video stream, such as by focusing on the area where the participants are located within the video. For example, the video modifier 124 can identify the locations of the participants within the video. The video modifier 124 can do so, for example, by generating or establishing a one-dimensional graph of the video and identifying the locations of the participants on the one-dimensional graph. The video modifier 124 can identify the location of the participants on other types of graphs, such as a two-dimensional graph or a three-dimensional graph that represents the dimensions of the video. The video modifier 124 can determine the locations of the participants based on the locations of the bounding boxes of the participants (e.g., a plurality of participants). The locations can be on the x-axis (e.g., the width of the video) or the y-axis (e.g., the length or height of the video), for example. The video modifier 124 can identify the locations of the bounding boxes and perform a function, such as a median or averaging function on the locations, to determine an action location (e.g., the median or average of the locations). In doing so, the video modifier 124 may only use the locations of the participants in the game session as input and not any other objects (e.g., playing objects, such as the ball or puck of the game session) within the frame. Using the median to determine action location can enable the video modifier 124 to avoid including individuals that are in outlier locations of the video (e.g., a referee on the opposite side of the court or a player that does not come back down to the court on defense) in determining how to modify the video. By using a function on the coordinates of the participants in the game session rather than other objects such as the playing object of the game session, the video modifier 124 can better capture the nuances of individual actions over the course of game sessions instead of only focusing on the singular object of the game session that may not be near other interesting aspects of the game session.

The video modifier 124 can adjust a zoom characteristic of the video. The video modifier 124 can do so based on the action location. For example, the video modifier 124 can zoom in (e.g., zoom in according to a predetermined or preconfigured zoom amount) on the video to generate zoomed-in images of the video and pan or move the zoom across the video such that the action location is within the zoomed-in images. In some embodiments, the video modifier 124 can pan the video such that the action location is at a predetermined location (e.g., the middle) of the zoomed-in images of the video. The video modifier 124 can crop out, delete, or remove the portions of the video that are not included in the zoomed-in images to generate a modified video or modified video stream.

In some embodiments, the video modifier 124 can dynamically determine zoom amounts for individual frames of the video. The video modifier 124 can do so, for example, according to a set of rules. For example, the video modifier 124 can store a rule that indicates a zoom amount such that the average or median height (e.g., length in the frame) of the participants in a frame is at or above a threshold amount or a rule that no height of a participant in the frame is below a threshold or above a threshold. In another example, the video modifier 124 can include a machine learning model that is trained to detect specific actions or events in a game (e.g., a free throw in a basketball game or a free kick in a soccer game), such as based on the positions of the individuals within the frame (e.g., by using the frame itself as input or by using positions of the participants identified by the individual detector 120 and/or the participant identifier 122 as numerical values as input). The video modifier 124 can store a mapping of zoom amounts or zoom ranges for zooming for the different events. The video modifier 124 can identify a zoom amount for a frame by determining an event in the frame and comparing the event to the mapping. In some cases, the video modifier 124 can use such rules in combination with the action location determined for each frame to determine a location to pan and an amount to zoom for each frame. The video modifier 124 can use the determined zoom amounts (e.g., instead of a predetermined or preconfigured zoom amount) with action locations to generate zoomed-in images of the video.

In some embodiments, the video modifier 124 can use a hierarchical rule structure to determine zoom amounts for frames. The hierarchical rule structure can include priorities for different rules. The priorities can indicate which rules to prioritize satisfying to avoid determining a zoom amount that satisfies a lower prioritized rule but that violates a higher prioritized rule. For example, there may be a rule that indicates to make sure each participant is depicted in a frame. The rule may have a highest priority. Another rule of a lower priority may indicate an average height threshold indicating a minimum average height of participants that a zooming amount can cause within a frame. Another rule of an even lower priority may indicate a zoom amount or a zoom range for a particular event type. The video modifier 124 can determine a zoom amount that satisfies the rules in descending order based on priority such as to ensure the higher priority rules are satisfied. For example, if rules 1, 2, 3, and 4 have descending priority, the video modifier 124 can determine a zoom amount that only satisfies rules 1, 2, and 4, but cannot determine a zoom amount only satisfies rules 2, 3, and 4. The hierarchical rule structure can include any number and/or type of rules. The video modifier 124 can similarly use this hierarchical rule structure for each frame of a video.

The video modifier 124 can perform an action on the modified video or modified video stream. For example, the video modifier 124 can transmit the modified video or modified video stream to the remote computing device 130 as a modified video 128. The remote computing device 130 can store the modified video 128 or encode and/or transmit the modified video 128 to other computing devices, such as to enable a real-time video feed for individuals that are not at the game session. The video modifier 124 can transmit the modified video or modified video stream to a computer hosting a streaming service (e.g., YOUTUBE, TWITCH, INSTAGRAM, FACEBOOK LIVE, HULU, VIMEO LIVESTREAM, etc.) and the computer can display the modified video or modified video stream through the streaming service. In doing so, the video modifier 124 can present the modified video or modified video stream to users accessing the streaming service in real-time. In another example, the video modifier 124 can store the modified video in the video database 126 (e.g., a relational database), such as for later viewing.

In some embodiments, the components 120-124 can modify stored videos. For example, the video database 126 can store one or more videos (e.g., unmodified videos). The individual detector 120 can retrieve a video from the video database 126. The individual detector 120 can do so responsive to receiving a request or user input, for example. The individual detector 120 can identify individuals in the video. The participant identifier 122 can identify participants in a game session of the video. The video modifier 124 can modify the video to focus on an action location over different frames of the video. The video modifier 124 can store the modified video back in the video database 126 and/or transmit the modified video to the remote computing device 130.

In some embodiments, the video modifier 124 can smooth out the movement of the modified video. The video modifier 124 can do so, for example, by caching frames or images of the video as the camera 104 generates or captures the frames. The video modifier 124 can also cache data or metadata (e.g., bounding boxes or locations of bounding boxes of the identified participants of games sessions) of the frames. The video modifier 124 can identify a defined number (e.g., one or more) of frames or identify one or more frames captured or generated within a predetermined time period (e.g., 30 frames captured within the last one second) of the current time and data or metadata of the identified frames. The video modifier 124 can determine a median of participant positions for each of the identified one or more frames. The video modifier 124 can determine a median (e.g., a smoothing median or an aggregate median) or another value of the determined medians of the identified one or more frames and use the determined median as the action location to zoom in on to generate the modified frames. In performing this process, the video modifier 124 can remove any medians that are a defined amount away from the average or median of the medians of the identified frames to remove noise. In some embodiments, the video modifier 124 can determine a median of all of the positions of the participants within the identified frames. The video modifier 124 can perform these operations over time within a moving time window to gradually change the action location and avoid jerking of the zoomed-in images of the modified video 128, for example.

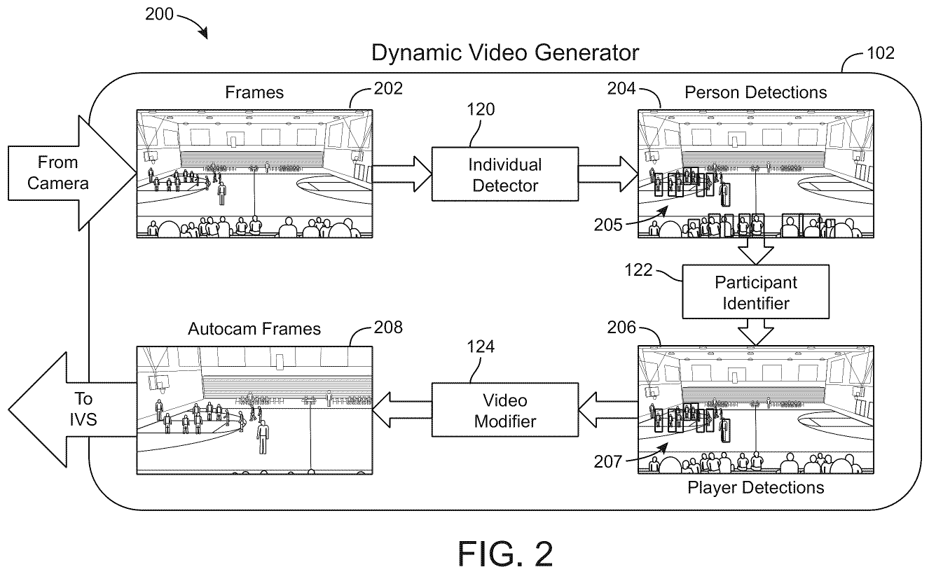

FIG. 2 is a sequence diagram of a sequence 200 of a computing device modifying frames of a video, according to some implementations. The sequence 200 can be performed by components of the system 100. For example, the sequence 200 can be performed by components of the dynamic video generator 102 as the dynamic video generator 102 captures a video of a basketball game. In another example, the sequence 200 can be performed by the video application 114 as the camera 104 captures video of a basketball game.

In the sequence 200, the individual detector 120 can receive frames 202 (e.g., images) of a video. The individual detector 120 can automatically detect individuals in the frames 202 as represented by bounding boxes 205 in frames 204. The participant identifier 122 can identify participants in the game session using a defined area that covers at least a portion or all of the court of the basketball game as illustrated by bounding boxes 207 (e.g., a subset of the bounding boxes 205) in the frames 206. The video modifier 124 can determine the locations of the participants and determine an action location based on the determined locations. The video modifier 124 can similarly determine an action location for individual frames of the frames 202 at a set frequency (e.g., at two frames-per-second up to 15 frames-per-second, for example). A defined number of frames can be randomly selected within a time frame for processing. The video modifier 124 can zoom in and pan to the action location on the same frames for which the action locations are determined or for a subsequently processed, obtained, or received frames of the frames 202. The video modifier 124 can crop or remove the portions of the frames 202 that are not included in the zoomed-in version of the frames to generate the modified frames 208. The dynamic video generator 102 can transmit the modified frames 208 as a modified video or modified video stream to a remote computing device (e.g., the remote computing device 130) and/or store the modified video or video stream in memory.

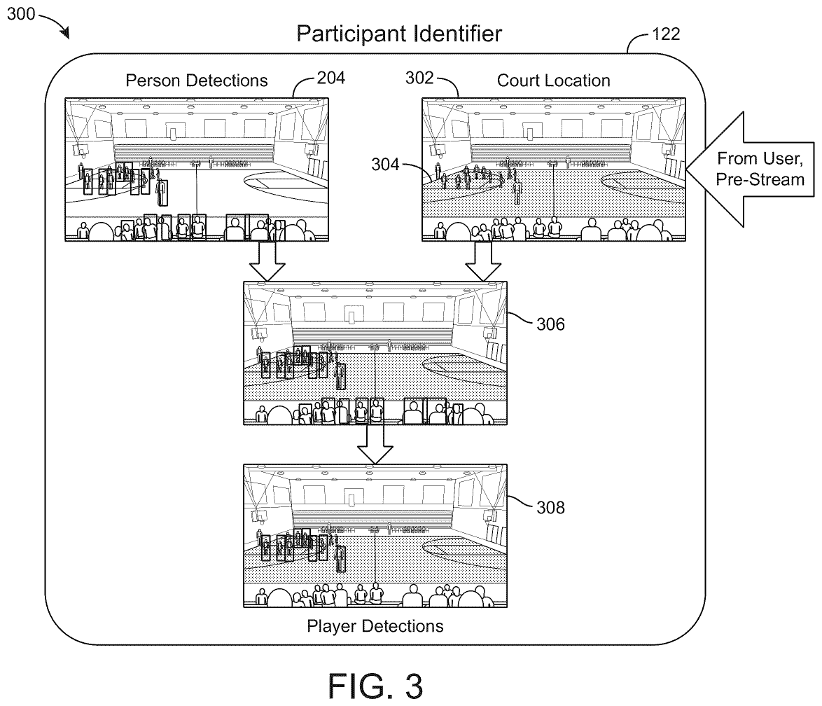

FIG. 3 is a sequence diagram of a sequence 300 for identifying participants of a game session, according to some implementations. The sequence 300 can be performed by components of the system 100. For example, the sequence 300 can be performed by the participant identifier 122. The sequence 300 can be performed by the participant identifier 122 during performance of the sequence 200 to identify participants in the game session from the frames 202 after the individual detector 120 detected individuals in the frames 202 as illustrated in the frames 204.

In the sequence 300, the participant identifier 122 can identify a defined area 304 of a video or video stream as illustrated in frames 302. The participant identifier 122 can receive the defined area 304 as a user input or the participant identifier 122 can automatically determine the defined area 304 using machine learning techniques on the frames 202. The participant identifier 122 can receive the indications of the bounding boxes representing locations of individuals within the frames 302. Frames 306 illustrate the defined area 304 and bounding boxes of the individuals depicted in the frames 302. The participant identifier 122 can compare the locations of the bounding boxes to the defined area 304. In the comparison, the participant identifier 122 can determine whether the bounding boxes are within the defined area 304 according to one or more rules, such as whether a defined portion (e.g., a defined percentage or defined part, such as the lower corners of the bounding boxes) of the bounding boxes are within the defined area 304. The participant identifier 122 can identify participants of the game session as the bounding boxes that satisfy the one or more rules, as illustrated in the frames 308. In this way, the participant identifier 122 can filter out spectators from the identified individuals of the frames 302.

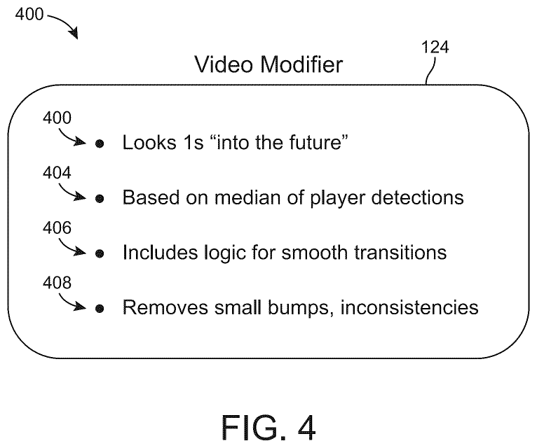

FIG. 4 is a depiction of functions 400 for modifying frames of a video, according to some implementations. The functions 400 can be performed by components of the system 100. For example, the functions 400 can be performed by the video modifier 124. The functions 400 can be performed by the video modifier 124 during performance of the sequence 200 to modify the frames 202 to generate modified frames after the participant identifier 122 identifies the participants in the game session that are depicted in the frames 202.

In performing a function 402, the video modifier 124 can look a defined time (e.g., one second) “into the future,” or determine a momentum of participants and/or objects in the video. In doing so, the video modifier 124 can build in latency between the frames that are processed to determine an action location for a video and the frames that the determined action location is used to modify. For example, the video modifier 124 can store the frames 202 and data or metadata (e.g., locations of participants or individuals in the frames 202) as the video modifier 124 receives the frames 202 and the corresponding data or metadata. The video modifier 124 can identify the positions of participants in a predetermined number (e.g., two or any other number) of the frames 202 captured or generated within the defined time of the current time (e.g., the video modifier 124 can identify 30 frames captured within the last one second and the positions of the participants in the predetermined number of the identified 30 frames).

In some embodiments, the video modifier 124 can use a look-ahead window within different ranges of built-in latency. For example, the video modifier 124 can build in a latency within a range of one frame to 30 frames (e.g., one second), one frame to 150 frames, or 30 frames to 150 frames.

The size of the look-ahead window may depend on the type of device modifying the video feed. For example, operating within a mobile phone, the video modifier 124 may build in a latency within a range of one frame to 30 frames. Operating on a server in the cloud, the video modifier 124 may operate within the range of one frame to 150 frames or 30 frames to 150 frames. Such differences may result from the different computing capacities of the different types of devices. The benefits of running in a lower range of frames are that doing so can reduce the number of frames to store in memory to use the look-ahead window or built-in latency. Devices such as mobile devices may have less memory and therefore use a smaller look-ahead window to preserve memory resources compared with servers operating in the cloud. Increasing the size of the look-ahead window may improve the quality of the generated video stream, but there may be diminishing returns after 150 frames (e.g., a look-ahead window longer than five seconds).

The video modifier 124 can determine the momentum of participants and/or objects in a video using any technique. For example, the video modifier 124 can use Kalman filters to track objects in videos with distinguishable velocities. In doing so, the video modifier 124 can detect the current state of each participant within individual frames of the video. The state can be a combination of position, velocity, and/or acceleration of an individual participant. The video modifier 124 can execute a motion model using the current state as input to generate a prediction state of each participant that indicates a new location (e.g., location within the frame or an environment captured by the frame), a new velocity, and/or a new acceleration of each participant. The motion model can be or include a computer model with a set of rules and/or algorithms for predicting a participant's future state (e.g., a prediction state). The video modifier 124 can identify the actual state of each participant in a subsequently captured frame of the video and use the actual states to repeat the process with the motion model to generate new predicted states for each of the participants. The video modifier 124 can predict states of participants in game sessions for each frame or frames at set intervals of the video in this way.

The video modifier 124 can use the predicted states of participants (e.g., the locations or positions of the predicted states of individuals) for a frame to determine an action location of the frame. For example, the video modifier 124 can determine a predicted state of participants in a first frame. The video modifier 124 can receive a second frame subsequent (e.g., immediately subsequent or as the next frame) to the first frame. The video modifier 124 can use the predicted state of participants based on the state of the participants in the first frame to determine the action location of the second frame. In doing so, the video modifier 124 can smooth zooming and/or panning actions when modifying the video.

The video modifier 124 can perform a function 404 to determine the median (or another output value) position (e.g., the predicted position or actual position) of the participants for each or for one or more of the predetermined number of the frames 202 for which the individual detector 120 and the participant identifier 122 identified participants of a game session. For example, the dynamic video generator 102 may receive frames of a video at a rate of 30 frames (or any number of frames) per second. The individual detector 120 and the participant identifier 122 may operate to identify participants in the game session at a rate of one frame-per-second up to 30 frames-per-second. The video modifier 124 can be configured to determine the medians of the positions of the participants in the game session for all or a defined number of the frames for which the participant identifier 122 identifies participants.

The video modifier 124 can perform a function 406 by performing a logic on the medians or the positions of the participants within the frames. The logic can involve identifying the action location for the frame captured at the defined time (e.g., the earliest frame in the time period between the defined time and the current time or the first frame of the frames captured within the last second). In one example, the logic can be to set the action location of the earliest frame to be the median of the participant positions in the frame of the current time, or the most recently captured frame. In another example, the logic can be to calculate an average or median of the player positions identified for the predetermined number of the frames 202 and setting the action location for the earliest frame to be the median of all of the player positions identified in the predetermined number of the frames 202 in a moving time window. In another example, the logic can involve detecting momentum changes. For instance, if the median in participant position of a first frame and a sequentially captured second frame is the same, but there is a large change (e.g., a change above a threshold) in the median in participant position between the second frame and a third frame sequentially captured after the second frame, the video modifier 124 may pan the zoomed-in frames to the action location between frames of the video or video stream more quickly or more aggressively. The video modifier 124 can do so, for example, using a Kalman filter.

In performing the function 406, the video modifier 124 can perform a function 408 to remove small bumps or inconsistencies (e.g., medians that are a standard deviation or other defined value away from the average or median of the 30 medians determined for the 30 frames) from the calculations, thus avoiding irrelevant data that may cause jerking motions in zoomed-in frames. The video modifier 124 can zoom in on the action location and crop out or remove any portions of the video that are not a part of the zoomed-in images.

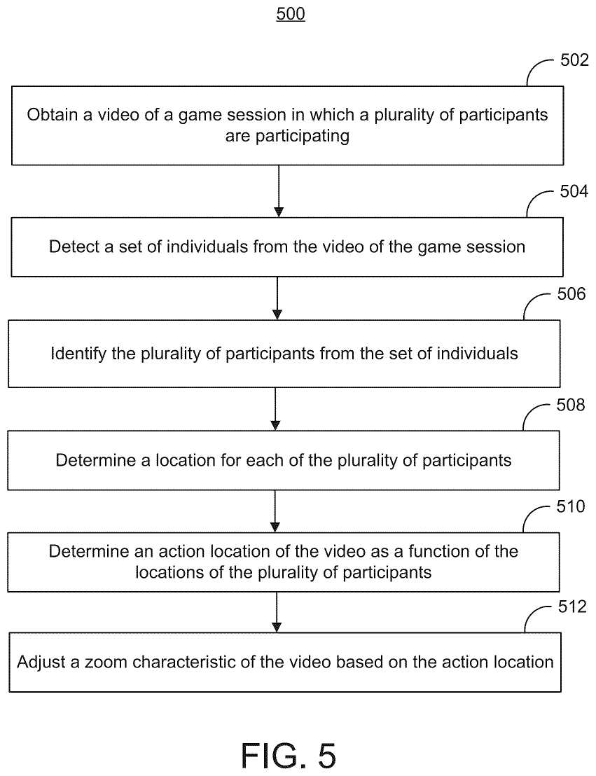

FIG. 5 is a flow chart of a method for dynamic video generation, according to some implementations. The method 500 may be performed by a data processing system (e.g., the dynamic video generator 102 or the remote computing device 130, shown and described with reference to FIG. 1, or any other computer or set of computers). The method 500 may include any number of steps and the steps may be performed in any order. Individual steps can be performed by different computing systems or processors. The data processing system may perform the method 500 to automatically modify videos or video streams of game sessions to dynamically focus on the activity in the game sessions. The data processing system can perform the method 500 on a single static feed (e.g., a stationary feed showing a static landscape view of a field on which a game session is being played) to generate the dynamic video or video feed.

In some embodiments, the data processing system may perform the method 500 as a web-based service offering. For example, the data processing system can receive a video or video stream over a network from one computing device. The data processing system can modify the video or video stream using the systems and methods described herein and send or stream a modified version of the video or video stream to the same computing device. In some cases, the data processing system can stream the modified version of the video or video stream to another computing device in communication with the data processing system. In some embodiments, the data processing system can transmit the modified version of the video of video feed to another computing device hosting a streaming service for streaming.

At step 502, the data processing system can obtain a video of a game session in which a plurality of participants are participating. In one example, the data processing system can obtain the video of the game session by receiving the video from a camera within the same housing as the processors of the data processing system or that is external to the data processing system. For instance, the data processing system can be a mobile phone and capture a video of the game session using a camera application and camera of the mobile phone or receive the video from an external camera in communication with the data processing system. In another example, the data processing system can obtain the video by retrieving the video from memory, such as in response to a request to automatically edit the video. In another example, the data processing system can receive a video across a network (e.g., across the Internet) after a user uploads the video to the network or receive a video stream across the network as the video stream is being captured.

At step 504, the data processing system can detect a set of individuals from the video of the game session. The data processing system can detect the set of individuals using machine learning techniques, such as by using an object detection machine learning model. The data processing system can detect the set of individuals in a frame of the video or video stream and generate bounding boxes for the individuals within the frame.

At step 506, the data processing system can identify the plurality of participants from the set of individuals. The data processing system can identify the plurality of participants from the set of individuals based on the locations of the bounding boxes within the frame. For example, the data processing system can identify a defined area within the frame. The defined area can be input by a user or determined using machine learning techniques. The data processing system can apply one or more rules to the bounding boxes of the detected individuals based on the locations of the bounding boxes relative to the defined area. In one example, the data processing system can determine the participants of the game session are individuals that are associated with bounding boxes in which a defined percentage of the bounding boxes are within the defined area or that have a defined portion (e.g., the bottom two corners) within the defined area. The data processing system may discard or remove the bounding boxes of the detected individuals of the frame from consideration. In doing so, the data processing system may filter out detected individuals of the frame that are spectators rather than participants of the game session.

At step 508, the data processing system can determine a location for each of the plurality of participants. The data processing system can determine the locations on a one-dimensional graph based on the frame. For example, the data processing system can determine the locations of the participants on one of an x-axis of the frame or a y-axis or both the x-axis and y-axis of the frame. Doing so can enable a zoomed in version of the video to move side-to-side or up-and-down without moving in the direction of another axis of the frame.

At step 510, the data processing system can determine an action location of the video as a function of the locations of the plurality of participants. The data processing system can do so, for example, by determining an average or a median of the locations of the participants within the one-dimensional graph of the frame. The data processing system can use any function to determine the action location of the video (e.g., the frame of the videos).

At step 512, the data processing system can adjust a zoom characteristic of the video based on the action location. In some embodiments, the data processing system can adjust the zoom characteristic of the video by zooming in on the frame by a defined or pre-configured amount and setting the middle of the zoomed-in version of the frame to be the determined action location. In some embodiments, the data processing system can adjust the zoom characteristic of the video by storing the action location of the frame in memory and setting the action location to be the middle of a zoomed-in version of a subsequent frame of the video. In some embodiments, the data processing system can determine the action locations of multiple frames over time in the manner described with reference to steps 502-510. The data processing system can store the action locations in memory. The data processing system can perform a function on the determined action locations to determine an aggregate action location and use the aggregate action location as the action location for a subsequently received frame of the video. In some embodiments, the data processing system can determine the action location of a subsequently received frame as a function of the positions of the participants over one or more previously received frames. The data processing system can repeat the process over time for individual frames of the video to generate an edited version of the video that focuses on the interesting content of the video. The data processing system can similarly edit video streams and/or stored videos that the data processing system retrieves from memory.

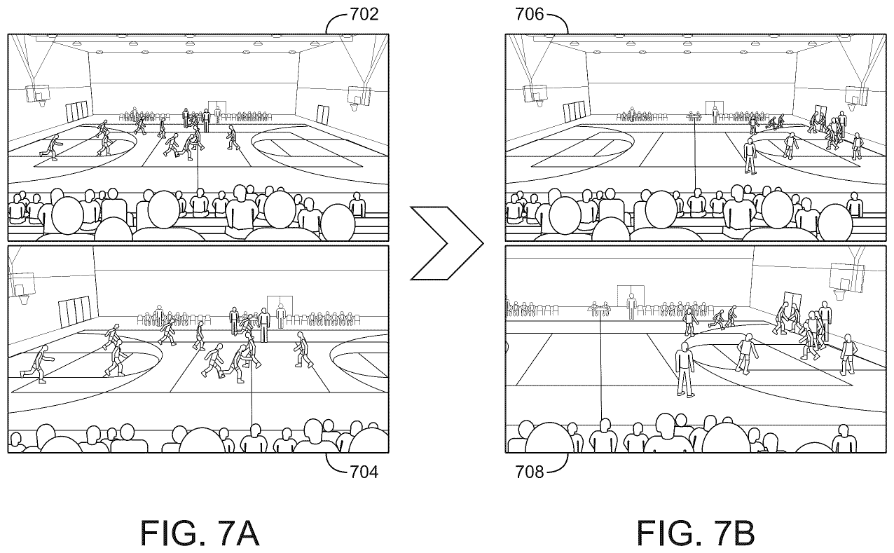

FIGS. 7A and 7B depict comparisons between modified and unmodified images, according to some implementations. FIG. 7A includes an unmodified image 702 and a modified image 704 of a video or video stream. A data processing system (e.g., the dynamic video generator 102 or the remote computing device 130, shown and described with reference to FIG. 1) can implement the systems and methods described herein to modify the unmodified image 702 to generate the modified image 704. FIG. 7B includes an unmodified image 706 and a modified image 708. The unmodified image 706 and the modified image 708 can be images of the same video stream or video as the unmodified image 702 and the modified image 704, but can occur at a later time in the video stream or video. The data processing system can implement the systems and methods described herein to modify the unmodified image 706 to generate the modified image 708.

### B. Computing Environment

Having discussed specific embodiments of the present solution, it may be helpful to describe aspects of the operating environment as well as associated system components (e.g., hardware elements) in connection with the methods and systems described herein.

The systems discussed herein may be deployed as and/or executed on any type and form of computing device, such as a computer, network device or appliance capable of communicating on any type and form of network and performing the operations described herein. FIGS. 6A and 6B depict block diagrams of a computing device 600 useful for practicing an embodiment of the systems and methods described herein. As shown in FIGS. 6A and 6B, each computing device 600 includes a central processing unit 621, and a main memory unit 622. As shown in FIG. 6A, a computing device 600 may include a storage device 628, an installation device 616, a network interface 618, an I/O controller 623, display devices 624a-624n, a keyboard 626 and a pointing device 627, such as a mouse. The storage device 628 may include, without limitation, an operating system and/or software. As shown in FIG. 6B, each computing device 600 may also include additional optional elements, such as a memory port 603, a bridge 670, one or more input/output devices 630a-630n (generally referred to using reference numeral 630), and a cache memory 640 in communication with the central processing unit 621.

The central processing unit 621 is any logic circuitry that responds to and processes instructions fetched from the main memory unit 622. In many embodiments, the central processing unit 621 is provided by a microprocessor unit, such as: those manufactured by Intel Corporation of Mountain View, California; those manufactured by International Business Machines of White Plains, New York; or those manufactured by Advanced Micro Devices of Sunnyvale, California. The computing device 600 may be based on any of these processors, or any other processor capable of operating as described herein.

Main memory unit 622 may be one or more memory chips capable of storing data and allowing any storage location to be directly accessed by the microprocessor 621, such as any type or variant of Static random access memory (SRAM), Dynamic random access memory (DRAM), Ferroelectric RAM (FRAM), NAND Flash, NOR Flash and Solid State Drives (SSD). The main memory 622 may be based on any of the above described memory chips, or any other available memory chips capable of operating as described herein. In the embodiment shown in FIG. 6A, the processor 621 communicates with main memory 622 via a system bus 680 (described in more detail below). FIG. 6B depicts an embodiment of a computing device 600 in which the processor communicates directly with main memory 622 via a memory port 603. For example, in FIG. 6B the main memory 622 may be DRDRAM.

FIG. 6B depicts an embodiment in which the main processor 621 communicates directly with cache memory 640 via a secondary bus, sometimes referred to as a backside bus. In other embodiments, the main processor 621 communicates with cache memory 640 using the system bus 680. Cache memory 640 typically has a faster response time than main memory 622 and is provided by, for example, SRAM, BSRAM, or EDRAM. In the embodiment shown in FIG. 6B, the processor 621 communicates with various I/O devices 630 via a local system bus 680. Various buses may be used to connect the central processing unit 621 to any of the I/O devices 630, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 624, the processor 621 may use an Advanced Graphics Port (AGP) to communicate with the display 624. FIG. 6B depicts an embodiment of a computer 600 in which the main processor 621 may communicate directly with I/O device 630b, for example via HYPERTRANSPORT, RAPIDIO, or INFINIBAND communications technology. FIG. 6B also depicts an embodiment in which local busses and direct communication are mixed: the processor 621 communicates with I/O device 630a using a local interconnect bus while communicating with I/O device 630b directly.

A wide variety of I/O devices 630a-630n may be present in the computing device 600. Input devices include keyboards, mice, trackpads, trackballs, microphones, dials, touch pads, touch screens, and drawing tablets. Output devices include video displays, speakers, inkjet printers, laser printers, projectors and dye-sublimation printers. The I/O devices may be controlled by an I/O controller 623 as shown in FIG. 6A. The I/O controller may control one or more I/O devices such as a keyboard 626 and a pointing device 627, e.g., a mouse or optical pen. Furthermore, an I/O device may also provide storage and/or an installation device 616 for the computing device 600. In still other embodiments, the computing device 600 may provide USB connections (not shown) to receive handheld USB storage devices such as the USB Flash Drive line of devices manufactured by Twintech Industry, Inc., of Los Alamitos, California.

Referring again to FIG. 6A, the computing device 600 may support any suitable installation device 616, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 600 may further include a storage device, such as one or more hard disk drives or redundant arrays of independent disks, for storing an operating system and other related software, and for storing application software programs such as any program or software 620 for implementing (e.g., configured and/or designed for) the systems and methods described herein. Optionally, any of the installation devices 616 could also be used as the storage device. Additionally, the operating system and the software can be run from a bootable medium.

Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 600 communicates with other computing devices 600′ via any type and/or form of gateway or tunneling protocol such as Secure Socket Layer (SSL) or Transport Layer Security (TLS). The network interface 618 may include a built-in network adapter, network interface card, PCMCIA network card, card bus network adapter, wireless network adapter, USB network adapter, modem or any other device suitable for interfacing the computing device 600 to any type of network capable of communication and performing the operations described herein.

In some implementations, the computing device 600 may include or be connected to one or more display devices 624a-624n. As such, any of the I/O devices 630a-630n and/or the I/O controller 623 may include any type and/or form of suitable hardware, software, or combination of hardware and software to support, enable or provide for the connection and use of the display device(s) 624a-624n by the computing device 600. For example, the computing device 600 may include any type and/or form of video adapter, video card, driver, and/or library to interface, communicate, connect or otherwise use the display device(s) 624a-624n. In one embodiment, a video adapter may include multiple connectors to interface to the display device(s) 624a-624n. In other embodiments, the computing device 600 may include multiple video adapters, with each video adapter connected to the display device(s) 624a-624n. In some implementations, any portion of the operating system of the computing device 600 may be configured for using multiple displays 624a-624n. One ordinarily skilled in the art will recognize and appreciate the various ways and embodiments that a computing device 600 may be configured to have one or more display devices 624a-624n.

In further embodiments, an I/O device 630 may be a bridge between the system bus 680 and an external communication bus, such as a USB bus, an Apple Desktop Bus, an RS-232 serial connection, a SCSI bus, a FireWire bus, a FireWire 500 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 600 of the sort depicted in FIGS. 6A and 6B may operate under the control of an operating system, which control scheduling of tasks and access to system resources. The computing device 600 can be running any operating system, such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to, Android, produced by Google Inc.; WINDOWS 7 and 8, produced by Microsoft Corporation of Redmond, Washington; MAC OS, produced by Apple Computer of Cupertino, California; WebOS, produced by Research In Motion (RIM); OS/2, produced by International Business Machines of Armonk, New York; and Linux, a freely-available operating system distributed by Caldera Corp. of Salt Lake City, Utah, or any type and/or form of a Unix operating system, among others.

The computer system 600 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 600 has sufficient processor power and memory capacity to perform the operations described herein.

In some implementations, the computing device 600 may have different processors, operating systems, and input devices consistent with the device. For example, in one embodiment, the computing device 600 is a smart phone, mobile device, tablet or personal digital assistant. In still other embodiments, the computing device 600 is an Android-based mobile device, an iPhone smart phone manufactured by Apple Computer of Cupertino, California, or a Blackberry or WebOS-based handheld device or smart phone, such as the devices manufactured by Research In Motion Limited. Moreover, the computing device 600 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices or stations (STAs), for example, consistent with the terms “user” and “multi-user”typically used in the context of a multi-user multiple-input and multiple-output (MU-MIMO) environment.

Although examples of communications systems described above may include devices operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some implementations, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, Python, Ruby, Go, Rust, Swift, Kotlin, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

What is claimed is:

1. One or more non-transitory computer-readable media for dynamic video generation, the non-transitory computer readable-media comprising instructions which, when executed by one or more processors, cause the one or more processors to:
obtain a video of a game session in which a plurality of participants are participating;
detect a set of individuals depicted in the video of the game session, the set of individuals comprising the plurality of participants;
determine a location for each of the plurality of participants within the video;
determine an action location of the video as a function of the location of each of the plurality of participants within the video; and
adjust a zoom characteristic of the video based on the action location.

2. The one or more non-transitory computer-readable media of claim 1, wherein execution of the instructions causes the one or more processors to:
identify the plurality of participants of the game session from the detected set of individuals detected in the video of the game session.

3. The one or more non-transitory computer-readable media of claim 2, wherein execution of the instructions causes the one or more processors to identify the plurality of participants responsive to determining the plurality of participants are located within a defined area of the video.

4. The one or more non-transitory computer-readable media of claim 3, wherein execution of the instructions further causes the one or more processors to receive the defined area as a user input.

5. The one or more non-transitory computer-readable media of claim 3, wherein execution of the instructions further causes the one or more processors to automatically identify the defined area from the video based on visual characteristics of a playing area for the game session depicted in the video.

6. The one or more non-transitory computer-readable media of claim 1, wherein execution of the instructions causes the one or more processors to determine the location for each of the plurality of participants by:
establishing a one-dimensional graph with an axis along a width of the video; and
determining the location for each of the plurality of participants within the video on the one-dimensional graph.

7. The one or more non-transitory computer-readable media of claim 6, wherein execution of the instructions causes the one or more processors to determine the action location of the video by determining a median of the determined locations of the plurality of participants on the one-dimensional graph.

8. The one or more non-transitory computer-readable media of claim 1, wherein execution of the instructions causes the one or more processors to adjust a zoom characteristic of the video by:
zooming in on the video according to a preconfigured zoom setting to generate zoomed-in frames of the video; and
moving the zoomed-in frames of the video such that the action location is within the zoomed-in frames.

9. The one or more non-transitory computer-readable media of claim 8, wherein execution of the instructions causes the one or more processors to move the zoomed-in frames of the video such that the action location is in a middle of the zoomed-in frames.

10. The one or more non-transitory computer-readable media of claim 8, wherein execution of the instructions causes the one or more processors to crop out any portions of the video that are not included in the zoomed-in frames.

11. The one or more non-transitory computer-readable media of claim 10, wherein execution of the instructions causes the one or more processors to transmit the zoomed-in frames to a remote computing device.

12. The one or more non-transitory computer-readable media of claim 1, wherein execution of the instructions causes the one or more processors to detect the set of individuals depicted in the video of the game session using an object detection machine learning model.

13. The one or more non-transitory computer readable media of claim 1, wherein execution of the instructions causes the one or more processors to:
store one or more first frames of the video in memory;
determine the action location of the video as a function of the location of each of the plurality of participants within the video for each of the one or more first frames of the video;
receive a second frame of the video subsequent to receiving the one or more first frames; and
adjust the zoom characteristic of the video by placing coordinates of the action location in a middle of the second frame received subsequent to the one or more first frames of the video.

14. The one or more non-transitory computer readable media of claim 13, wherein execution of the instructions causes the one or more processors to determine the action location of the video as a function of the location of each of the plurality of participants within the video for each of a plurality of frames of the video.

15. A system for dynamic video generation, comprising:
one or more processors coupled to one or more computer-readable storage media, the one or more processors configured to execute instructions stored on the one or more computer-readable storage media to:
obtain a video of a game session in which a plurality of participants are participating;
detect a set of individuals depicted in the video of the game session, the set of individuals comprising the plurality of participants;
determine a location for each of the plurality of participants within the video;
determine an action location of the video as a function of the location of each of the plurality of participants within the video; and
adjust a zoom characteristic of the video based on the action location.

16. The system of claim 15, wherein execution of the instructions causes the one or more processors to identify the plurality of participants of the game session from the detected set of individuals detected in the video of the game session.

17. The system of claim 16, wherein execution of the instructions causes the one or more processors to identify the plurality of participants responsive to determining the plurality of participants are located within a defined area of the video.

18. A method for dynamic video generation, comprising:
obtaining, by one or more processors, a video of a game session in which a plurality of participants are participating;
detecting, by the one or more processors, a set of individuals depicted in the video of the game session, the set of individuals comprising the plurality of participants;
identifying, by the one or more processors, the plurality of participants of the game session from the detected set of individuals detected in the video of the game session responsive to determining the plurality of participants are located within a defined area of the video;
determining, by the one or more processors, a location for each of the plurality of participants within the video;
determining, by the one or more processors, an action location of the video as a function of the location of each of the plurality of participants within the video; and
adjusting, by the one or more processors, a zoom characteristic of the video based on the action location.

19. The method of claim 18, further comprising receiving, by the one or more processors, the defined area as a user input.

20. The method of claim 18, further comprising:
automatically identifying, by the one or more processors, the defined area from the video based on visual characteristics of a playing area for the game session depicted in the video.
